(19) United States
(12) Patent Application Publication
(10) Pub. No.: US 2024/0225350 A1
(43) Pub. Date: Jul. 11, 2024

(54) Malleable Cover for Cooking Including a Reinforcing Arrangement

(71) Applicant: Tina Bill, Sand Springs, OK (US)

(72) Inventor: Tina Bill, Sand Springs, OK (US)

(21) Appl. No.: 18/543,980

(22) Filed: Dec. 18, 2023

Related U.S. Application Data
(60) Provisional application No. 63/478,783, filed on Jan. 6, 2023.

(51) Int. Cl. A47J 36/06; A47J 36/02

(52) U.S. Cl. CPC A47J 36/06; A47J 36/02

(57) ABSTRACT

A reinforced cooking sheet having reinforcing members configured on an area of the cooking sheet. The reinforcing members provide support for the malleable cooking sheet to be formed to fit over a cookable food item in a cooking vessel. The reinforcing members can be configured in pattern into the cooking sheet. The cooking sheet includes a margin area without reinforcing members designed to fold over an upper edge of handle of a cooking vessel.

### CROSS-REFERENCE TO RELATED APPLICATIONS

This application claims the benefit of priority of U.S. Provisional Patent Application No. 63/478,783, filed on Jan. 6, 2023, the disclosure of which is herein incorporated by reference in its entirety.

### BACKGROUND

### 1. FIELD

The present invention relates generally to cooking articles, and more particularly to vessel covering articles.

### 2. DESCRIPTION OF THE RELATED ART

Disposable and inexpensive culinary tools designed to cover cooking vessels, e.g., for lining and covering food items, have become commonplace in the modern kitchen to help speed up necessary cooking and cleaning. These liners and covers can be made of a variety of materials including but not limited to aluminum, plastic, and paper. These liners and covers vary in heat resistance as well as in having the ability to form by bending and, for example, with Aluminum foil, being made malleable to be crushed onto vessel edges. Aluminum foil is the common choice for liner/cover use in the oven because of its high heat resistance, ability to crease and be uncreased, and low cost.

### SUMMARY

In some embodiments, the techniques described herein relate to a cover for cooking vessels, the cover including: a sheet included of a malleable heat resistant, heat conductive metal; a plurality of reinforcing members formed on one or more sides of the sheet, the reinforcing members extending across an internal portion of the sheet, and stopping short a margin area of the sheet; the reinforcing members forming a grid area sized to extend over a top opening of a cooking vessel; and the margin configured to engage an upper rim of the cooking vessel.

In some embodiments, the techniques described herein relate to a process for making a cover for a cooking vessel, the process including: providing a sheet included of a malleable heat resistant, heat conductive metal; forming the sheet to have integral reinforcing members into a grid in an area sized to cover the cooking vessel; configuring margins of the sheet in the forming step to be substantially flat and to cling to one or more upper rim components of the cooking vessel.

In some embodiments, the techniques described herein relate to a system for covering a cooking vessel, the system including: a non-toxic, food-safe, metal sheet member; a plurality of reinforcing members formed into a grid on a first side of the sheet member to create a reinforcing pattern; margins established around at least some of the first side of the sheet, the margins being substantially flat.

### DESCRIPTION OF THE SEVERAL VIEWS OF THE DRAWINGS

FIG. 1 discloses a first, front side of a cooking sheet formed such that a reinforcing arrangement exists on the first side;

FIG. 2 discloses a second, plain, back side of the sheet which, in embodiments, is substantially flat;

FIG. 3 shows section 3-3 taken from FIG. 1;

FIG. 4 shows the first side of the sheet and shows the foldable nature of the sheet having reinforcements; and

FIG. 5 is a side sectional view revealing an implementation of the disclosed embodiment used on a vessel to cook a food item.

### DETAILED DESCRIPTION

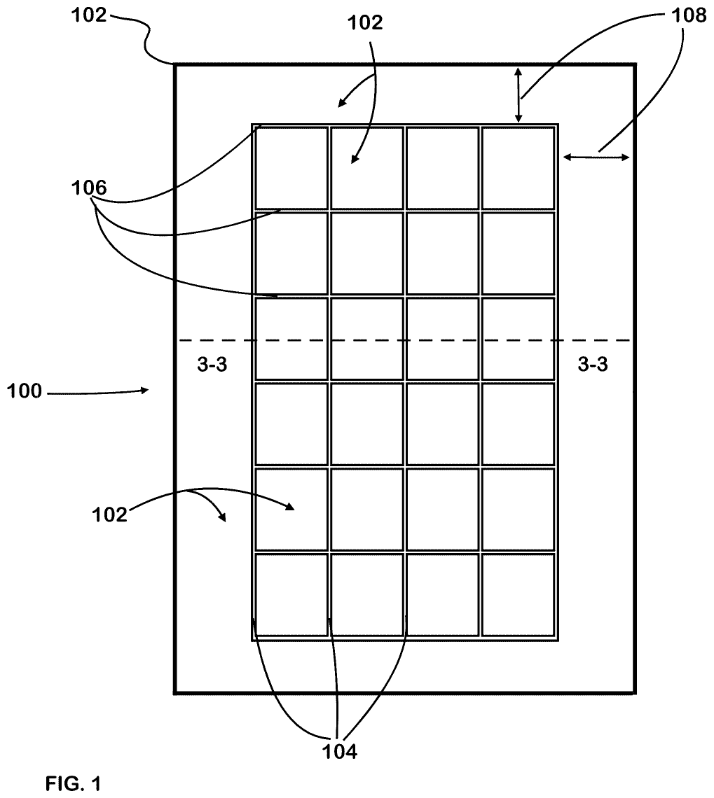

FIG. 1 shows an embodiment 100 having a first side 102 produced to include a plurality of evenly spaced reinforcing members 104 running in a first direction and a second group of evenly spaced reinforcing members 106 running in a second direction perpendicular to the first group 104. Together, the first and second groups of reinforcing members 104 and 106 form a rectangular orthogonal grid which is surrounded by a reinforcing-member-free margin area 108. In embodiments, the smooth member free margin area 108 exists about the entire periphery of the cover as shown in the figures and includes a substantially consistent width.

Although FIG. 1 shows the formation of a rectangular orthogonal grid, it is also possible that the grid would comprise some non-orthogonal configuration arrangement could be formed of substantially spaced-apart longitudinal members running in only one direction such that the sheet is reinforced in only one dimension. The term “grid” as used in this application should not be considered as limiting to any particular arrangement disclosed, but instead could include any arrangement including reinforcing members that span the internal areas of either side of the sheet 100. The gaps on the sheet between the reinforcing members exist as flat areas. The flat areas between the reinforcing members could be uniform (as shown in FIG. 1) or be irregularly shaped (curved, have diverse sizes, etc.).

Alternatively, the embodiment 100 could be formed such that the reinforcing members run along the length of the sheet 100 to form a sort of spaced-apart waved members which do not cross. Further, the reinforcing members could have curved configurations which do or do not cross. Still, numerous other possibilities include spirals, or some other complex configuration. Numerous other patterns are possible such as repeating multi-sided polygons (e.g., triangles, pentagons, hexagons, or parallelograms), round-shaped figures with no corners, and S-shaped or wavy versions of the shapes mentioned herein. The size of the shapes used to create the embodiment 100 may be smaller or larger than the preferred embodiment shown, and again, sized consistently or inconsistently.

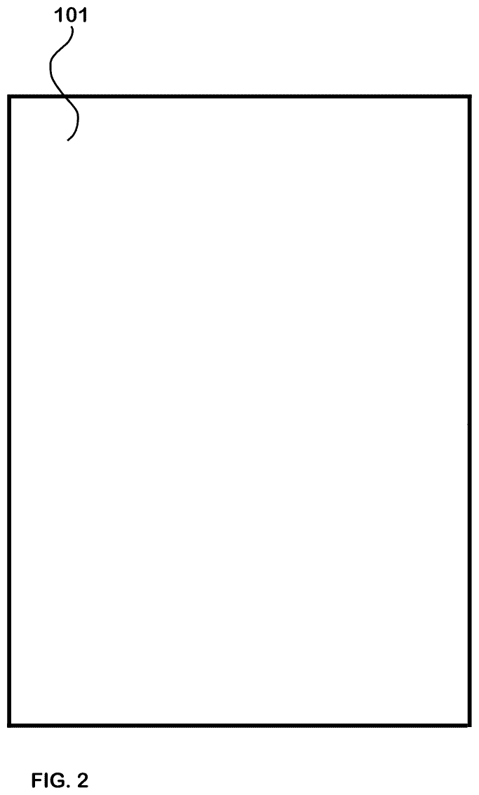

FIG. 2 shows a back view of the malleable aluminum foil sheet 100 that in the preferred embodiment, has a second, plain side 101. Alternatively, second side 101 could be formed to have an additional grid structure formed thereon. For example, in addition to the structures on the first side complementary longitudinally extending reinforcing members, or some other reinforcing mechanisms could be formed into, or adhered or otherwise mounted onto second side 101. In embodiments, the sheet 100 may be fabricated from Aluminum or possibly from a malleable heat resistant and heat conductive metal. In some embodiments, the sheet 100 may be fabricated from a non-toxic, food-safe material.

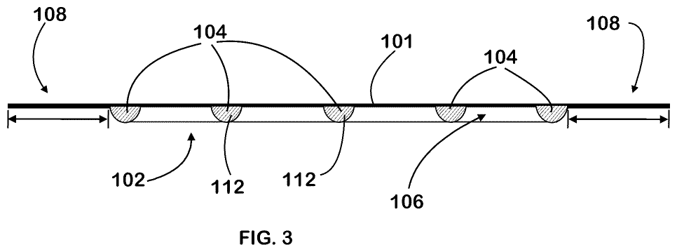

FIG. 3. is a cross-section view taken at Section 3-3 from FIG. 1. Referring to the figure, it can be seen that the malleable aluminum foil sheet 100 reveals how the first set of reinforcing members 104 would look, in an embodiment, in the sectional view. The appearance of reinforcing members 106, if viewed in section, would appear to have a similar cross-sectional shape. In terms of shape, it can be seen that each reinforcing member 104 has been formed to have a substantially semi-circular cross section 112. The perpendicular reinforcing members 106, would, in embodiments, have a substantially similar shape. It should be noted, however, that in cross section, any or all the reinforcing members could have circular, square, or any other cross-sectional shape and still fall within the broad aspects of what is disclosed herein.

Processes of manufacture are also disclosed. In one embodiment, the reinforcing members (e.g., members 104 and 106) are integrally formed along with the sheet from a relatively thicker initial preprocessed aluminum sheet. From the initial material, the sheet construction is formed, in embodiments, as the result of a metal rolling process. In this process, a roller device is configured to have recessed areas. These recessed areas match the pattern intended to be produced on the first side 102 of the sheet 100. For embodiments where a roller is used, the roller would be formed such that areas of the reinforcing-member free margin area 108 do not include any recesses, thus resulting in substantially flat margins on first side 102.

Alternatively, the members could be stamped onto the sheet instead of rolled wherein the die includes voids dictating the pattern resulting, and the reciprocating margins on the die are void free resulting in the desired flatness. The reinforcing members could also be adhered in some fashion to the first side of the sheet. In such an embodiment, the devices could be cylindrically cross sectioned reinforcing members or have some other cross-sectional shape, and the cylindrical rods would be truncated at the margins to allow for the desired shape.

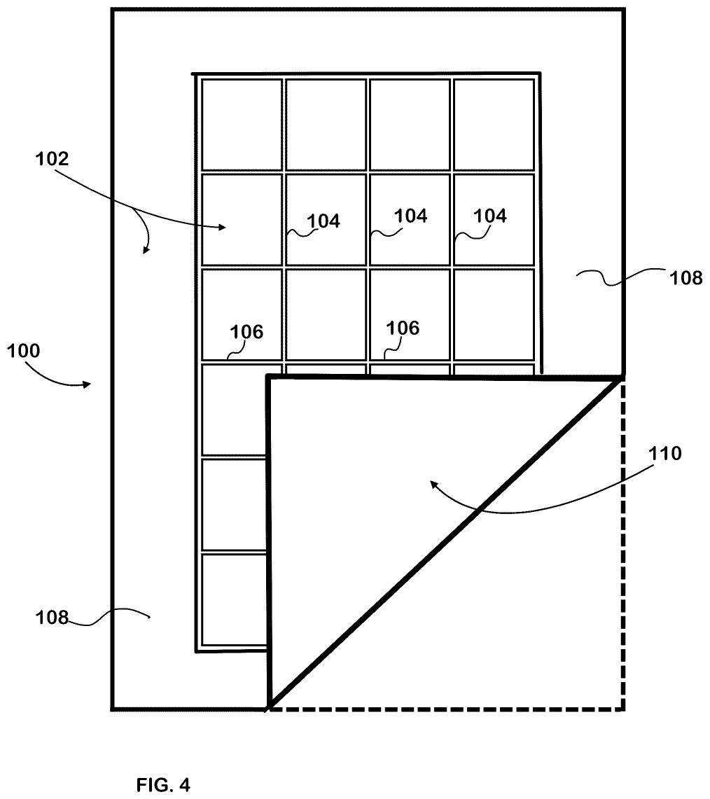

FIG. 4. is a top view of the malleable aluminum foil sheet 100 folded over to show the back view of the malleable aluminum foil sheet second side 101 to show the two sides of the invention simultaneously. The figure also shows the malleable nature of the sheet.

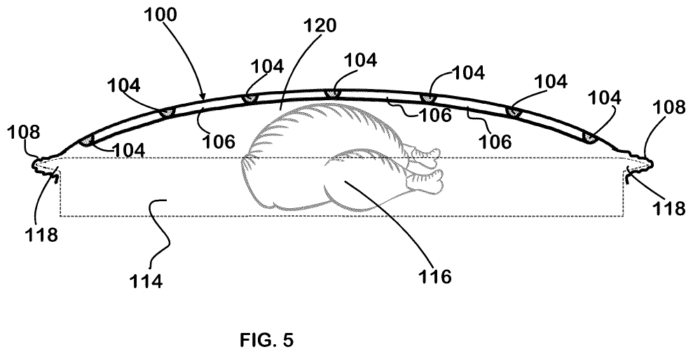

FIG. 5. is an illustration of the aluminum foil sheet that can be used to cover a cooking vessel 114 (e.g., a casserole dish) according to the embodiments of the present invention. FIG. 5 reveals a half section taken at the center vertical axis in one view of a substantially rectangular vessel 114, the upper opening of which is substantially the same as the extend of the reinforcing grid 104, 106 established on the sheet 100. The sheet 100 could alternatively be configured such that the grid pattern 104, 106 was configured to match any different shape of vessel upper opening.

As can be seen in FIG. 5, the cooking vessel is shown to be a dish including a cookable food item 116 which has been covered with the reinforced sheet 100. The unreinforced margins 108 have been crumpled to latch onto an upper rim area at the upper edges of the walls of the cooking vessel 114, which, e.g., might include one or more handles 118 as shown in FIG. 5. The margins 108 are folded over the rim onto the smooth areas on the upper outside of the vessel 114. Because the sheet 100 is reinforced, it will be able to provide and better hold a clearance area 120 between the top of the food product 116 and the underside of the sheet 100 so that the food item cannot cling to or be baked onto the reinforced sheet 100. This provides a significant advantage over prior art Aluminum foil arrangements.

Alternatively still, the sheet 100 could be used to be extended over to cover food items on a grill without creating food contact.

1. A cover for cooking vessels, the cover comprising:
a sheet comprised of a malleable heat resistant, heat conductive metal;
a plurality of reinforcing members formed on one or more sides of the sheet, the reinforcing members extending across an internal portion of the sheet, and stopping short a margin area of the sheet;
the reinforcing members forming a grid area sized to extend over a top opening of a cooking vessel; and
the margin configured to engage an upper rim of the cooking vessel.

2. The cover of claim 1 wherein a first group of reinforcing members run across a second group of reinforcing members on the sheet.

3. The cover of claim 2 wherein the first group of reinforcing members are substantially perpendicular to the second group of reinforcing members.

4. The cover of claim 2 wherein the first and second groups of reinforcing members form a grid pattern.

5. The cover of claim 4 wherein the grid pattern is an orthogonal grid pattern.

6. The cover of claim 5 wherein the orthogonal grid pattern covers a substantially rectangular area.

7. The cover of claim 1 wherein margin area exists about substantially the entire periphery of the sheet.

8. The cover of claim 1 wherein the reinforcing members form a grid leaving substantially flat areas between the reinforcing members on the sheet.

9. The cover of claim 8 wherein the substantially flat areas between the reinforcing members areas in at least portions of the sheet are uniformly shaped.

10. The cover of claim 8 wherein the substantially flat areas between the reinforcing members areas in at least portions of the sheet are diversely shaped.

11. The cover of claim 1 wherein the reinforcing members are spaced apart and waved.

12. The cover of claim 1 wherein the reinforcing members each have a substantially semi-circular cross section.

13. The cover of claim 1 wherein the malleable heat resistant, heat conductive metal is Aluminum.

14. The cover of claim 1 wherein the reinforcing members are integrally formed along with the sheet.

15. A process for making a cover for a cooking vessel, the process comprising:
providing a sheet comprised of a malleable heat resistant, heat conductive metal;
forming the sheet to have integral reinforcing members into a grid in an area sized to cover the cooking vessel;
configuring margins of the sheet in the forming step to be substantially flat and to cling to one or more upper rim components of the cooking vessel.

16. The process of claim 15 comprising:
executing the forming step using a roller.

17. The process of claim 15 comprising:
configuring the reinforcing members to hold a form wherein the sheet passes above an exterior surface of a cookable food item.

18. A system for covering a cooking vessel, the system comprising:
a non-toxic, food-safe, metal sheet member;
a plurality of reinforcing members formed into a grid on a first side of the sheet member to create a reinforcing pattern;
margins established around at least some of the first side of the sheet, the margins being substantially flat.

19. The system of claim 18 wherein said reinforcing members are comprised of the same material to the sheet member and the reinforcing members are integral with respect to the sheet member.

20. The system of claim 18 wherein the margins comprise a width sufficient to enable the margins to be either folded or crimped around an edge of the cooking vessel.
